(19) United States
(12) Patent Application Publication
(10) Pub. No.: US 2026/0100461 A1
(43) Pub. Date: Apr. 9, 2026

(54) POWER TOOL SYSTEM HAVING A BATTERY PACK

(71) Applicant: Michael E. Nipke, LLC, Wyoming, MI (US)

(72) Inventor: Michael E. Nipke, Wyoming, MI (US)

(21) Appl. No.: 19/348,037

(22) Filed: Oct. 2, 2025

Related U.S. Application Data
(60) Provisional application No. 63/704,751, filed on Oct. 8, 2024.

(51) Int. Cl. H01M 50/247; B25F 5/02; H01M 50/213

(52) U.S. Cl. CPC H01M 50/247; B25F 5/02; H01M 50/213; H01M 2220/30

(57) ABSTRACT

The power tool system includes a power tool device and a battery pack that has battery cells organized in an arrangement that may improve the usability of the power tool device. The power tool device can slidably engage with the battery pack along a sliding axis extending in a longitudinal direction. The power tool device can operate a tool that may rotate about a rotation axis that extends in the longitudinal direction. The power tool device includes a handle having a centerline axis that passes through a surface of the handle and extends in the longitudinal direction. The battery cells have axes that extend in the longitudinal direction to align with the centerline, rotation, and/or sliding axes. The battery cells are disposed in a nested arrangement so that the space occupied by the battery pack may be reduced.

### CROSS REFERENCE TO RELATED APPLICATION

The present application claims the benefit of U.S. provisional application, Ser. No. 63/704,751, filed on Oct. 8, 2024, which is hereby incorporated herein by reference in its entirety.

### FIELD OF THE DISCLOSURE

The present disclosure relates to power systems, and, more particularly, to a power tool system having a battery pack.

### BACKGROUND

Users may use power tools to accomplish a variety of tasks relating to construction, home repairs, automotive maintenance, metalworking, etc. Many types of power tools are available for use, such as power drills/drivers, impact drivers, rotary tools, saws, sanders, polishers, and the like. A power tool may be powered by a cord that is electrically coupled to the power tool and an electrical outlet. However, the power tool may additionally or alternatively be powered by a battery pack that is electrically coupled to the power tool. The battery pack may store energy so that the battery pack can power the power tool. For example, the battery pack may be a rechargeable battery pack having one or more battery cells that can be electrically coupled to an external power source (e.g., the electrical outlet) to charge the battery pack.

### SUMMARY

A power tool system includes a power tool device and a battery pack having battery cells in an arrangement that may improve the usability of the power tool device. The arrangement of the battery cells may reduce the space occupied by the battery pack to thereby reduce the likelihood that the battery pack will interfere during the performance of the power tool system such as, for example, when used in tight spaces like cabinets and/or corners. The power tool device can slidably engage with the battery pack along a sliding axis that extends in a longitudinal direction. After the power tool device is engaged with the battery pack, the power tool device can be powered by the battery pack to operate a tool (e.g., a drill tool). The power tool device may operate the tool by rotating the tool about a rotation axis that extends in the longitudinal direction. The power tool device includes a handle having a surface that can be gripped by a user while operating the power tool system. The handle has a centerline axis that passes through the surface and extends in the longitudinal direction.

The battery cells in the battery pack have longitudinal axes that extend in the longitudinal direction so that the longitudinal axes align with the centerline, rotation, and/or sliding axes. This organization of the battery cells enables the use of alternative batteries while maintaining an acceptable width of the battery pack, including enabling the use of battery cells (e.g., 21700 battery cells) that are larger than traditional battery cells and provide sufficient or more power to the power tool device than traditional battery cell arrangements. In particular, the arrangement enables the use of larger batteries without necessitating an increase in the overall width of the battery pack relative to a traditional arrangement of batteries, including enabling the use of fewer batteries. The space occupied by the arrangement of the battery cells may further be reduced by organizing the battery cells in a nested arrangement such as, for example, five battery cells in a “star” arrangement. The smaller space occupied by the nested arrangement may allow for a reduction in a space occupied by the battery pack.

In one example of the present disclosure, a power tool system includes a battery pack and a power tool device that can be coupled to the battery pack. The battery pack has a housing and battery cells within the housing. The battery cells have longitudinal axes that extend in a longitudinal direction. The power tool device can rotate a tool about a rotation axis of the power tool while the power tool device is coupled to the battery pack. The rotation axis extends in the longitudinal direction.

In another example, the power tool device includes a handle having a surface that can be gripped by a user while using the power tool device. The handle has a grip centerline axis passing through the surface that extends in the longitudinal direction.

In yet another example, the housing has a first connector, and the power tool device has a second connector. The second connector can slidably engage with the first connector along a sliding axis that extends in the longitudinal direction to couple the power tool device to the housing of the battery pack.

In yet another example, the battery cells have first battery cells aligned with one another in a lateral direction perpendicular to the longitudinal direction. The battery cells also have second battery cells that are laterally aligned with one another and vertically aligned with the first battery cells.

In yet another example, the battery cells have a third battery cell between the first and second battery cells.

In another example of the present disclosure, a power tool system includes a battery pack and a power tool device that can be coupled to the battery pack. The battery pack has a housing and battery cells within the housing. The battery cells have longitudinal axes extending in a longitudinal direction. The power tool device includes a handle having a surface that can be gripped by a user while using the power tool device. The handle has a grip centerline axis passing through the surface and extending in the longitudinal direction.

In another example, the housing includes a first connector, and the power tool device includes a second connector. The second connector can slidably engage with the first connector along a sliding axis that extends in the longitudinal direction to couple the power tool device to the housing of the battery pack.

In yet another example, the battery cells have first and second battery cells aligned with one another in a lateral direction perpendicular to the longitudinal direction. The battery cells also have third and fourth battery cells that are: (i) laterally aligned with one another; (ii) offset from the first and second battery cells in a vertical direction perpendicular to the longitudinal and lateral directions; and (iii) vertically aligned with respective ones of the first and second battery cells.

In yet another example, the battery cells have a fifth battery cell between the first, second, third, fourth, and fifth battery cells.

In yet another example of the present disclosure, a battery pack has a housing and battery cells within the housing. The battery cells have longitudinal axes that extend in a longitudinal direction. The battery pack also has a connector coupled to the housing. The connector can slidably engage with a power tool device along a sliding axis that extends in the longitudinal direction.

In another example, the battery cells have first and second battery cells. The first battery cell is offset from the second battery cell in a vertical direction perpendicular to the longitudinal direction.

In another example, the first battery cell is vertically aligned with the second battery cell.

In another example, the battery cells have third and fourth battery cells. The third battery cell is aligned with the first battery cell in a lateral direction perpendicular to the longitudinal and vertical directions. The fourth battery cell is vertically aligned with the third battery cell and laterally aligned with the second battery cell.

In another example, the first battery cell is further offset from the second battery cell in a lateral direction perpendicular to the vertical and longitudinal directions.

In another example, the first battery cell includes a first circumference having a first uppermost point and a first lowermost point. The second battery cell includes a second circumference having a second lowermost point disposed vertically between the first uppermost and lowermost points.

In another example, further including a third battery cell that has a third circumference. The third circumference has a third uppermost point and a third lowermost point. The second circumference further includes a second uppermost point disposed vertically between the third uppermost and lowermost points.

In another example, the third battery cell is vertically aligned with the first battery cell.

In another example, the battery cells have fourth and fifth battery cells. The fourth battery cell is laterally aligned with the third battery cell. The fifth battery cell is laterally aligned with the first battery cell and vertically aligned with the fourth battery cell. The second uppermost and lowermost points are laterally between the first, third, fourth, and fifth battery cells.

In another example, the battery cells extend from a first plane perpendicular to said longitudinal direction to a second plane perpendicular to said longitudinal direction.

In another example, the battery cells have a length of 70 millimeters that extend in the longitudinal direction, and a diameter of 21 millimeters.

Thus, the power tool system may allow a user to more easily operate power tool devices. This is accomplished by the power tool system including a battery pack that has battery cells organized in a way to reduce the space occupied by the arrangement of the battery cells. The organization may reduce the space occupied by the arrangement of the battery cells by having the longitudinal axes of the battery cells extend in a longitudinal direction and align with the centerline axis of the handle, the rotation axis of the power tool device, and/or the sliding axis of the battery pack. The organization can further reduce the space occupied by the arrangement of the battery cells by organizing the battery cells in the nested arrangement (e.g., the “star” arrangement). The smaller space occupied by the arrangement of the battery cells may allow for a reduction in the space occupied by the battery pack to lessen the interference of the battery pack while using the power tool system. Further, the organization of the battery cells may narrow the width occupied by the arrangement of the battery cells while providing sufficient or greater power to the power tool device and including battery cells that may be larger than traditional battery cells such as, for example, 21700 battery cells.

These and other objects, advantages, purposes, and features of this disclosure will become apparent upon review of the following specification in conjunction with the drawings.

### BRIEF DESCRIPTION OF DRAWINGS

FIG. 1 is a side elevation view of a power tool system having a battery pack;

FIG. 2 is a front elevation view of the battery pack of FIG. 1;

FIG. 3 is another front elevation view of the battery pack of FIG. 1 with internal components partially visible showing battery cells;

FIG. 4 is a front sectional view of the battery pack of FIG. 1 showing battery cells;

FIG. 5 is a side sectional view of the battery pack of FIG. 1 showing battery cells;

FIG. 6 is another side sectional view of the battery pack of FIG. 1 showing battery cells; and

FIG. 7 is a rear elevation view of the battery pack of FIG. 1.

### DETAILED DESCRIPTION

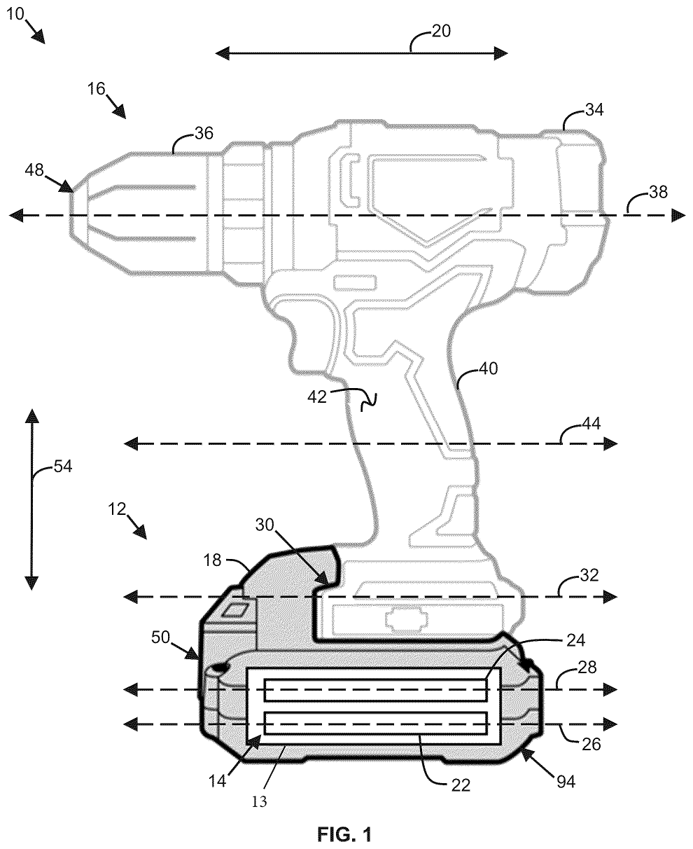

Referring now to the drawings and illustrative examples depicted therein, a power tool system 10 includes a battery pack 12 having a battery assembly 13 with battery cells 14 in a compact arrangement that allows a user to more readily operate the power tool system 10 and/or enables the battery pack 12 to use alternatively sized batteries, such as larger batteries, without an increase in the width of the battery pack 12 relative to traditional battery arrangements. This includes enabling fewer batteries to be used while still providing sufficient or greater power to the power tool device 16. The power tool system 10 may be any suitable power tool equipment that can operate a tool. For example, as shown in FIG. 1, the power tool system 10 may be a power drill that has a power tool device 16 to rotate a tool, such as a drill bit, a wire brush, a sanding drum, or the like. The drill tool may be rotated for a variety of tasks, such as for drilling a screw into an object.

The power tool device 16 is powered by the battery pack 12 that may allow the user to operate the power tool system 10 in a handheld manner without being connected to an external power source. (FIG. 1). The battery pack 12 has a housing 18 that contains the battery assembly 13 with the battery cells 14 for powering the power tool device 16. The battery cells 14 may be any suitable battery, wherein the illustrated embodiment depicts the battery cells 14 as 21700 cylindrical lithium-ion battery cells.

The battery cells 14 have longitudinal axes that extend in a longitudinal direction 20 relative to the longitudinal orientation of power tool device 16. (FIG. 1). For example, as shown in FIG. 1, a first battery cell 22 and a second battery cell 24 have respective first and second longitudinal axes 26, 28. The battery cells 14 can power the power tool device 16 when the battery pack 12 is electrically coupled to the power tool device 16. The battery cells 14 may be electrically coupled to the power tool device 16 via one or more electrical elements of the battery assembly 13 such as, for example, wire(s) and/or electrical connector(s). For example, the battery cells 14 may be electrically coupled to the power tool device 16 via a frame of the battery assembly 13 in the housing 18 that may have one or more electrical elements and support the battery cells 14.

The power tool device 16 may have a connector that can be coupled to a connector 30 of the battery pack 12 so that the power tool device 16 can be electrically coupled to the battery pack 12. (FIGS. 1, 6). For example, the power tool connector can slidably engage with the battery pack connector 30 along a sliding axis 32 to couple the power tool device 16 to the battery pack 12. The sliding axis 32 may extend in the longitudinal direction 20. (FIG. 1). The connector of the power tool device 16 and the connector 30 of the battery pack 12 may have one or more fastening elements such as, for example slip-fit element(s) (e.g., a slot element, a groove element) and/or snap-fit element(s) (e.g., a latch element, a tab element) so that the power tool device 16 can be selectively mechanically coupled to the battery pack 12. Further, the connector of the power tool device 16 and the connector 30 of the battery pack 12 may have one or more electrical elements such as, for example, electrical pin(s), electrical contact(s), and/or electrical prong(s) so that the power tool device 16 can be selectively electrically coupled to the battery pack 12.

After the power tool device 16 is coupled to the battery pack 12, the power tool device 16 can obtain power from the battery pack 12 to operate a tool. (FIG. 1). For example, the power tool device 16 may include a head 34 having a chuck 36 that can be coupled to a drill tool. The chuck 36 can rotate the drill tool about a rotation axis 38 that extends in the longitudinal direction 20.

The head 34 of the power tool device is coupled to a handle 40 of the power tool device 16 that has a surface 42 for the user to grip while using the power tool system 10. (FIG. 1). The handle 40 has a centerline axis 44 that passes through the surface 42 and extends in the longitudinal direction 20. As such, the centerline axis 44 of the handle 40, the rotation axis 38 of the power tool device 16, the sliding axis 32 of the battery pack connector 30, and/or the longitudinal axes (e.g., the longitudinal axes 26, 28) of the battery cells 14 are aligned by extending in the longitudinal direction 20.

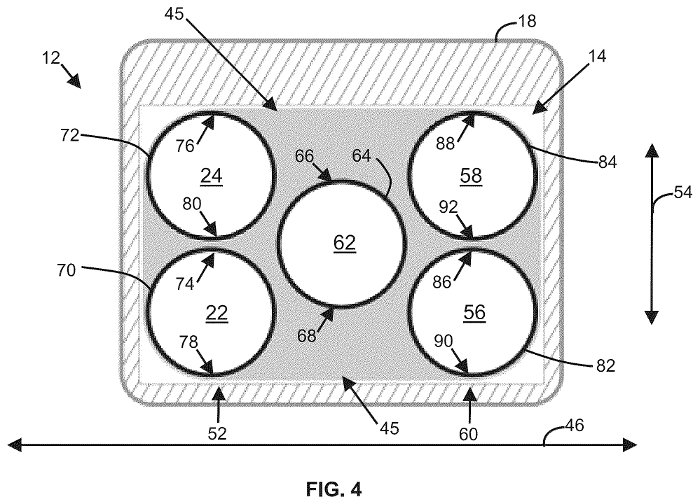

The longitudinal axes (e.g., the longitudinal axes 26, 28) of the battery cells 14 being aligned with the sliding, rotation, and/or centerline axes 32, 38, 44 of the power tool device 16 allows the battery pack 12 to have the battery cells 14 of larger footprints while not negatively impacting a footprint 45 of the arrangement of the battery cells 14 and/or the performance of the power tool system 10. (FIGS. 3, 4). As used herein, the term footprint is defined as a space occupied by one or more elements such as, for example, the width, length, and/or height of the element(s). For instance, in the illustrated embodiment, the battery cells 14 are 21700 cylindrical lithium-ion battery cells that have lengths of 70 millimeters extending in the longitudinal direction 20 and diameters of 21 millimeters. The 21700 battery cells may have footprints greater than traditional battery cells (e.g., 18650 battery cells) in traditional battery packs of power tools. The longitudinal arrangement of the battery cells 14 may allow the footprint 45 to be narrower than footprints of traditional battery cell arrangements in traditional battery packs.

In addition to the longitudinal arrangement of battery cells 14, the footprint 45 of the arrangement of the battery cells 14 may be further reduced by organizing the battery cells 14 in a nested arrangement. (FIGS. 3, 4). For example, the nested arrangement may have the battery cells 14 organized in a “star” arrangement as shown in FIGS. 3 and 4 and discussed in more detail below.

The smaller footprint 45 of the arrangement of the battery cells 14 may allow the footprint of the battery pack 12 to be reduced. The smaller footprint of the battery pack 12 may allow a user to more easily operate the power tool system 10. For example, when the user is operating the power tool system 10, the battery pack 12 having the smaller footprint may reduce the likelihood of interferences by the battery pack 12 such as, for example, bumping into surfaces and/or fitting into tight spaces (e.g., cabinets, corners). Moreover, the longitudinal arrangement of the battery cells 14 allows the use of batteries having longer length with greater power capacity to be used than if batteries are arranged laterally.

The footprint of the battery pack 12 and the footprint 45 of the arrangement of the battery cells 14 may be reduced without negatively impacting the power tool system 10. For example, the battery cells 14 may have five 21700 cylindrical lithium-ion battery cells that may allow the battery pack 12 to provide a voltage rating of 20 Volts. For a traditional battery pack having battery cells that have lengths extending in a lateral direction 46 (FIGS. 3, 4) perpendicular to the longitudinal direction 20, the traditional battery pack may require a larger footprint to obtain the voltage rating of 20 Volts.

Thus, the power tool system 10 can improve the operation of the power tool system 10 by having the battery cells 14 in the compact arrangement that may have an improved footprint 45 to improve the footprint of the battery pack 12. This is accomplished by the battery cells 14 being organized so that the longitudinal axes (e.g., the longitudinal axes 26, 28) of the battery cells 14 extend in the longitudinal direction 20, including relative to the longitudinal orientation of the battery pack 12, and align with the centerline axis 44 of the handle 40, the rotation axis 38 of the power tool device 16, and/or the sliding axis 32 of battery pack connector 30. The footprint 45 of the longitudinal arrangement of the battery cells 14 may further be reduced by organizing the battery cells 14 in a nested arrangement such as, for example, five battery cells in a “star” arrangement. The compact, longitudinal arrangement of battery cells 14 can be obtained while providing sufficient power to the power tool device 16 and including the battery cells 14 that have greater footprints such as, for example, 21700 battery cells.

Referring to FIG. 1, the battery pack 12 may have a footprint that improves the usability of the power tool system 10 so that a user can more easily operate the power tool system 10. For example, as shown in FIG. 1, the head 34 has a front end 48 (e.g., the front end of the chuck 36) that extends laterally beyond a front end 50 of the battery pack 12. The front end 50 of the battery pack 12 not extending as far as the front end 48 of the head 34 may allow the user to access more areas such as, for example, tight spaces (e.g., cabinets, corners) without being restricted by the battery pack 12.

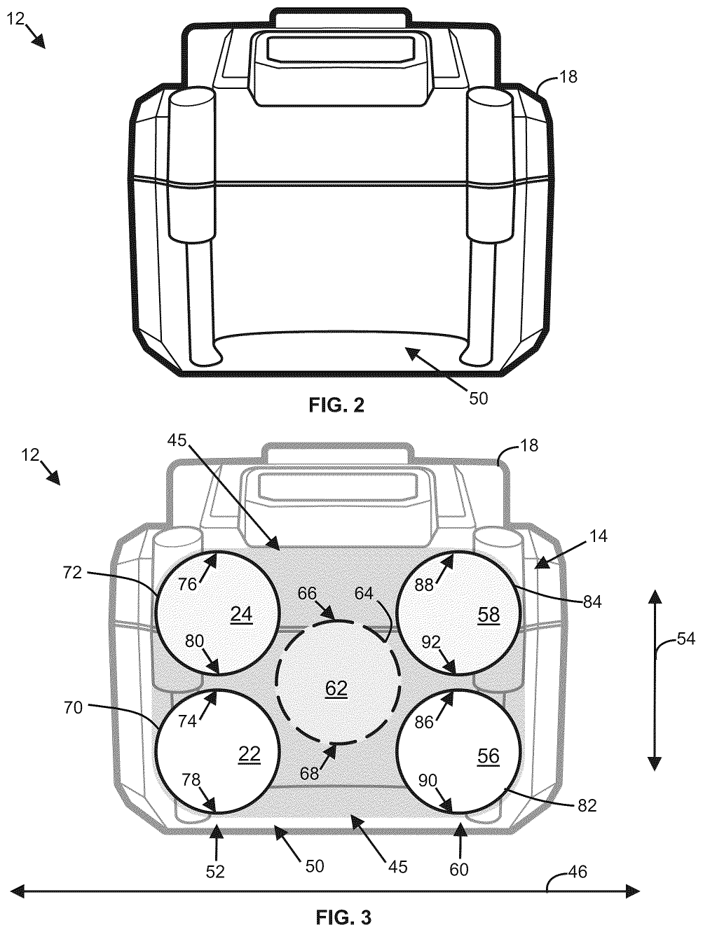

FIGS. 2 and 3 show the front end 50 of the battery pack 12. The battery pack 12 shown in FIG. 3 further illustrates a transparent layer representing the battery cells 14 within the housing 18 of the battery pack 12.

As best shown in FIGS. 3 and 4, the battery cells 14 may be organized in a nested “star” arrangement that may improve the footprint 45 of the arrangement of the battery cells 14. For example, the footprint 45 may have a smaller width that extends along the lateral direction 46 compared to footprints of traditional arrangements in power tools. The battery cells 14 may include the first battery cell 22 and the second battery cell 24 that are arranged in a first column 52. The first battery cell 22 may be offset from the second battery cell 24 in a vertical direction 54 that is perpendicular to the longitudinal and lateral directions 20, 46. Further, the first and second battery cells 22, 24 may be vertically aligned with one another.

The battery cells 14 may have a third battery cell 56 and a fourth battery cell 58 that are arranged in a second column 60. (FIGS. 3, 4). The third battery cell 56 may be vertically offset from the fourth battery cell 58 and/or vertically aligned with the fourth battery cell 58. The third and fourth battery cells 56, 58 of the second column 60 may be offset from the first column 52 in the lateral direction 46. Further, the third and fourth battery cells 56, 58 of the second column 60 may be laterally aligned with respective ones of the first and second battery cells 22, 24 of the first column 52.

The battery cells 14 may have a fifth battery cell 62 that is between the first, second, third, and fourth battery cells 22, 24, 56, 58. (FIGS. 3, 4). The fifth battery cell 62 may be vertically and laterally offset from the first, second, third, and fourth battery cells 22, 24, 56, 58.

The fifth battery cell 62 includes a circumference 64 that has an uppermost point 66 and a lowermost point 68 with respect to the vertical direction 54. (FIGS. 3, 4). The first and second battery cells 22, 24 also include respective circumferences 70, 72 having respective uppermost points 74, 76 and lowermost points 78, 80 with respect to the vertical direction 54. The uppermost point 66 of the fifth battery cell 62 may be disposed vertically between the uppermost and lowermost points 76, 80 of the second battery cell 24, and the lowermost point 68 of the fifth battery cell 62 may be disposed vertically between the uppermost and lowermost points 74, 78 of the first battery cell 22.

The third and fourth battery 56, 58 include respective circumferences 82, 84 having respective uppermost points 86, 88 and lowermost points 90, 92 with respect to the vertical direction 54. (FIGS. 3, 4). The uppermost point 66 of the fifth battery cell 62 may be disposed vertically between the uppermost and lowermost points 88, 92 of the fourth battery cell 58, and the lowermost point 68 may be disposed vertically between the uppermost and lowermost points 86, 90 of the third battery cell 56. The uppermost and lowermost points 66, 68 of the fifth battery cell 62 may be disposed laterally between the first, second, third, and fourth battery cells 22, 24, 56, 58.

In the illustrated embodiment, the longitudinal axes of the first and second cells 22, 24 are aligned along a first vertical plane, and the longitudinal axes of the third and fourth cells 56, 58 are aligned along a second vertical plane. Additionally, the longitudinal axes of the first cell 22, fifth cell 62 and fourth cell 58 are aligned along a straight line, and the longitudinal axes of the second cell 24, fifth cell 62 and third cell 56 are aligned along a straight line. The longitudinal axis of the fifth cell 62 is vertically below the longitudinal axes of the second and fourth cells 24, 58 and vertically above the first and third cells 22, 56. Moreover, the nesting of the fifth cell 62 means that a line tangent to the first and second cells 22, 24 will either be tangent to the fifth cell 62 or approximately tangent thereto. In a particular embodiment, the outer circumference of the fifth cell 62 would be intersected by a line tangent to the first and second cells 22, 24. In another embodiment it would not be, such as may be disposed within a few millimeters thereof. The fifth cell 62 is similarly disposed relative to the third and fourth cells 56, 58.

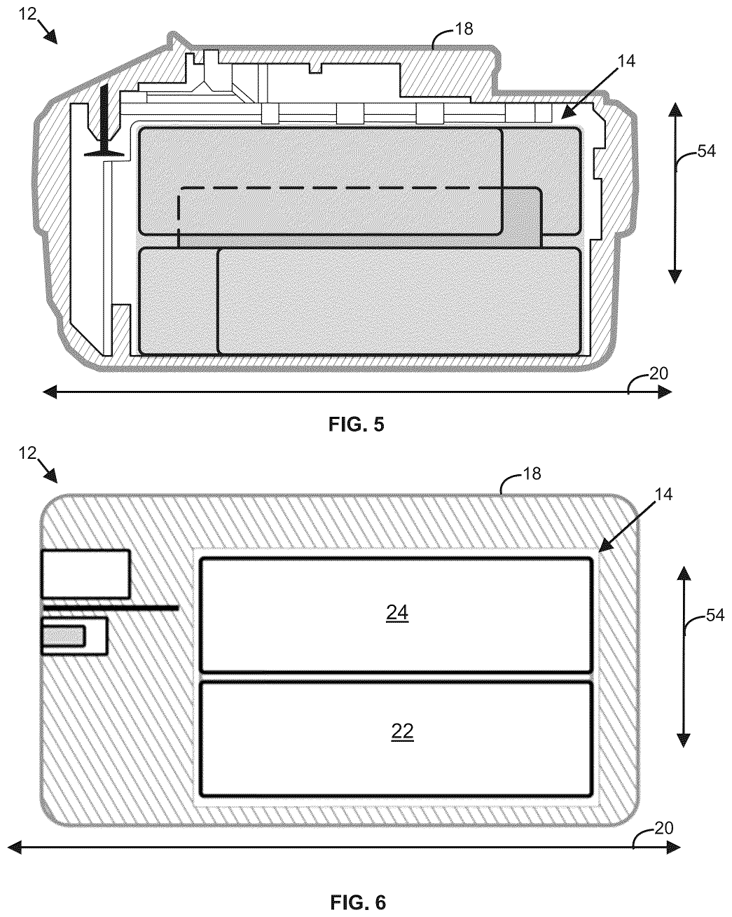

FIGS. 5 and 6 show side elevation views of the battery pack 12 extending in the longitudinal direction 20 and the vertical direction 54. The battery cells 14 may extend from a first plane perpendicular to the longitudinal direction 20 to a second plane perpendicular to the longitudinal direction 20. (FIG. 6).

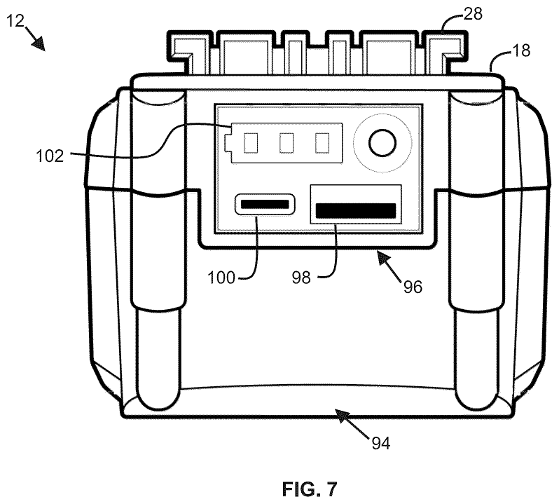

FIG. 7 shows a rear end 94 of the battery pack 12. As shown in FIG. 7, the battery pack 12 has one or more charging ports 96 to recharge the battery cells 14. For example, the battery pack 12 may have one or more Universal Serial Bus (USB) ports, such as a USB-A port 98 and/or a USB-C port 100. The battery pack 12 may have a charge indicator 102 to indicate the level of charge stored in the battery cells 14 and/or the status of a charging mode (e.g., charging from an external power source) for the user of the power tool system 10. The charge indicator 102 may have one or more display devices such as, for example, light-emitting diode(s) and/or liquid crystal display(s).

Accordingly, the power tool system includes the battery pack having battery cells in an arrangement that may improve the footprint of the battery pack without negatively impacting the power tool system. The battery cells may be organized so that the longitudinal axes of the battery cells extend in the longitudinal direction and align with the centerline axis of the handle of the power tool device, the rotation axis of the power tool device, and/or the sliding axis of battery pack connector. This organization of the battery cells may allow the footprint of the arrangement of the battery cells to be narrower while including battery cells that have greater footprints (e.g., 21700 batteries) and provide sufficient power to the power tool device. The footprint of the arrangement of the battery cells may further be improved by organizing the battery cells in a nested arrangement such as, for example, five battery cells in a “star” arrangement. The smaller footprint provided by the arrangement of the battery cells can improve the usability of the power tool system.

Although some of the elements shown in the power tool system 10 share the same numbering, this does not imply the elements are identical. Further, although an example of the power tool system 10 is shown in FIGS. 1-7, one or more of the elements illustrated in FIGS. 1-7 may be combined, divided, re-arranged, omitted, and/or implemented in any other way. For example, although the column 52 shows the first and second cells 22, 24 as being vertically aligned with one another, the first and second cells 22, 24 may be vertically offset.

Further, the power tool system 10 shown in FIGS. 1-7 may include one or more elements in addition to and/or instead of the elements illustrated in FIGS. 1-7, and/or may include more than one of the elements illustrated in FIGS. 1-7. For example, the power tool system 10 may have additional battery cells.

Connection relationships between elements are described herein using various terms, such as “coupled”, “connected”, “engaged,” etc. As used herein, connection relationships can be direct relationships and/or indirect relationships where one or more intervening elements are between the first and second elements.

Spatial relationships of elements are described herein using various terms such as, for example, “lateral”, “longitudinal”, “vertical”, “uppermost”, “lowermost”, “front”, “rear”, “side”, etc. As used herein, spatial relationships of the elements do not limit the orientations of the elements as other orientations of the elements may be used.

Directional descriptors are used to describe the arrangement of elements. As used herein, the term “laterally” is used to describe the lateral direction 46, the term “vertically” is used to describe the vertical direction 54, and the term “longitudinally” is used to describe the longitudinal direction 20.

It should be understood that “including”, “comprising”, and “having” (and all other forms, such as tenses) are used herein to be open-ended terms. Thus, whenever a claim recites any form of “include”, “comprise”, or “have” (e.g., comprises, includes, has, comprising, including, having) as a preamble or within a claim recitation of any kind, it is to be understood that additional elements, terms, etc. may be present without falling outside the scope of the corresponding claim.

As used herein, singular references (e.g., “a”, “an”, “first”, “second”) do not exclude a plurality. The term “a” or “an” entity refers to one or more of that entity. The terms “a” (or “an”), “one or more”, and “at least one” can be used interchangeably. The term “and/or” when used in a form such as, for example, A, B, and/or C refers to any combination or subset of A, B, C such as (1) A alone, (2) B alone, (3) C alone, (4) A with B, (5) A with C, (6) B with C, and (7) A with B and with C.

Changes and modifications in the specifically described examples can be carried out without departing from the principles of the present disclosure which is intended to be limited only by the scope of the appended claims, as interpreted according to the principles of patent law including the doctrine of equivalents.

1. A power tool system comprising:
a battery pack having a housing and a plurality of battery cells within said housing, wherein said battery cells have longitudinal axes extending in a longitudinal direction; and
a power tool device configured to be coupled to said battery pack, wherein said power tool device is configured to rotate a tool about a rotation axis of said power tool device while said power tool device is coupled to said battery pack, and wherein said rotation axis extends in said longitudinal direction.

2. The power tool system of claim 1, wherein said power tool device comprises a handle having a surface configured to be gripped by a user while using said power tool device, wherein said handle has a grip centerline axis passing through said surface that extends in said longitudinal direction.

3. The power tool system of claim 1, wherein said housing comprises a first connector, and said power tool device comprises a second connector, wherein said second connector is configured to slidably engage with said first connector along a sliding axis extending in said longitudinal direction to couple said power tool device to said housing of said battery pack.

4. The power tool system of claim 1, wherein said battery cells comprise a plurality of first battery cells aligned with one another in a lateral direction perpendicular to said longitudinal direction, and a plurality of second battery cells that are laterally aligned with one another and vertically aligned with said first battery cells.

5. The power tool system of claim 4, wherein said battery cells comprise a third battery cell between said first and second battery cells.

6. A power tool system comprising:
a battery pack having a housing and a plurality of battery cells within said housing, wherein said battery cells have longitudinal axes extending in a longitudinal direction; and
a power tool device configured to be coupled to said battery pack, wherein said power tool device comprises a handle having a surface configured to be gripped by a user while using said power tool device, wherein said handle has a grip centerline axis passing through said surface and extending in said longitudinal direction.

7. The power tool system of claim 6, wherein said housing further comprises a first connector, and said power tool device comprises a second connector, wherein said second connector is configured to slidably engage with said first connector along a sliding axis extending in said longitudinal direction to couple said power tool device to said housing of said battery pack.

8. The power tool system of claim 6, wherein said battery cells comprise first and second battery cells aligned with one another in a lateral direction perpendicular to said longitudinal direction, and third and fourth battery cells: (i) laterally aligned with one another; (ii) offset from said first and second battery cells in a vertical direction perpendicular to said longitudinal and lateral directions; and (iii) vertically aligned with respective ones of said first and second battery cells.

9. The power tool system of claim 8, wherein said battery cells comprise a fifth battery cell between said first, second, third, fourth, and fifth battery cells.

10. A battery pack comprising:
a housing;
a plurality of battery cells within said housing, wherein said battery cells have longitudinal axes extending in a longitudinal direction; and
a connector coupled to said housing, wherein said connector is configured to slidably engage with a power tool device along a sliding axis that extends in said longitudinal direction.

11. The battery pack of claim 10, wherein said battery cells comprise first and second battery cells, wherein said first battery cell is offset from said second battery cell in a vertical direction perpendicular to said longitudinal direction.

12. The battery pack of claim 11, wherein said first battery cell is vertically aligned with said second battery cell.

13. The battery pack of claim 12, further comprising third and fourth battery cells, wherein said third battery cell is aligned with said first battery cell in a lateral direction perpendicular to said longitudinal and vertical directions, and wherein said fourth battery cell is vertically aligned with said third battery cell and laterally aligned with said second battery cell.

14. The battery pack of claim 11, wherein said first battery cell is further offset from said second battery cell in a lateral direction perpendicular to said vertical and longitudinal directions.

15. The battery pack of claim 14, wherein said first battery cell comprises a first circumference having a first uppermost point and a first lowermost point, wherein said second battery cell comprises a second circumference having a second lowermost point disposed vertically between said first uppermost and lowermost points.

16. The battery pack of claim 15, wherein said battery cells comprise a third battery cell including a third circumference having a third uppermost point and a third lowermost point, wherein said second circumference further comprises a second uppermost point disposed vertically between said third uppermost and lowermost points.

17. The battery pack of claim 16, wherein said third battery cell is vertically aligned with said first battery cell.

18. The battery pack of claim 17, wherein said battery cells comprise fourth and fifth battery cells, wherein said fourth battery cell is laterally aligned with said third battery cell, wherein said fifth battery cell is laterally aligned with said first battery cell and vertically aligned with said fourth battery cell, and wherein said second uppermost and lowermost points are laterally between said first, third, fourth, and fifth battery cells.

19. The battery pack of claim 10, wherein said battery cells extend from a first plane perpendicular to said longitudinal direction to a second plane perpendicular to said longitudinal direction.

20. The battery pack of claim 10, wherein said battery cells have a length of 70 millimeters that extend in said longitudinal direction, and a diameter of 21 millimeters.
